(19) United States
(12) Patent Application Publication
(10) Pub. No.: US 2009/0058941 A1
(43) Pub. Date: Mar. 5, 2009

(54) METHODS AND APPARATUS FOR MODULAR PRINT HEAD AND ADAPTER AND ROTATION THEREOF WITH INKJET PRINTER SYSTEMS

(75) Inventors: Shinichi Kurita, San Jose, CA (US); Benjamin Johnston, Los Gatos, CA (US)

Correspondence Address: DUGAN & DUGAN, PC, 245 Saw Mill River Road, Suite 309, Hawthorne, NY, 10532, US

(73) Assignee: APPLIED MATERIALS, INC., Santa Clara, CA (US)

(21) Appl. No.: 12/202,190

(22) Filed: Aug. 29, 2008

Related U.S. Application Data
(60) Provisional application No. 60/968,872, filed on Aug. 29, 2007.
(60) Provisional application No. 60/992,725, filed on Dec. 6, 2007.

(51) Int. Cl. B41J 2/14

(52) U.S. Cl. 347/49

(57) ABSTRACT

Methods, systems and apparatus are provided for use with an inkjet printing system. In some embodiments, an apparatus is provided, comprising an adapter including one or more supply lines, wherein the one or more supply lines are adapted to transmit at least one of ink and solvent to a print head. Numerous other aspects are provided.

The present application claims priority from:

U.S. Provisional Patent Application Ser. No. 60/968,872, filed Aug. 29, 2007, entitled “MODULAR PRINT HEAD AND ADAPTER FOR INKJET PRINTER SYSTEMS” (Attorney Docket No. 11534/L1); and

U.S. Provisional Patent Application Ser. No. 60/992,725, filed Dec. 6, 2007, entitled “METHODS AND APPARATUS FOR FACILITATING ROTATION OF INKJET PRINT HEADS” (Attorney Docket No. 11534/L2), both of which are hereby incorporated herein by reference in their entirety for all purposes.

### CROSS-REFERENCE TO RELATED APPLICATIONS

The present application is related to the following commonly-assigned, co-pending U.S. patent applications, each of which is hereby incorporated herein by reference in its entirety for all purposes:

U.S. patent application Ser. No. 11/019,930, filed Dec. 22, 2004, and entitled, “METHODS AND APPARATUS FOR ALIGNING PRINT HEADS” (Attorney Docket No. 9521-3); and

U.S. patent application Ser. No. 11/466,507, filed Aug. 23, 2006, and entitled, “METHOD AND APPARATUS FOR INKJET PRINTING COLOR FILTERS FOR DISPLAYS USING PATTERN DATA” (Attorney Docket No. 9521-P04).

### FIELD OF THE INVENTION

The present invention relates generally to flat panel display manufacturing, and more particularly to methods and apparatus for inkjet printing.

### BACKGROUND OF THE INVENTION

Inkjet printing has been employed as a method for producing color filters for flat panel displays. According to this method, ink drops are jetted through a plurality of nozzles of an inkjet print head onto an array of pixel wells arranged on a substrate. The nozzles may be arranged in a line at a fixed pitch. The print head may include a plurality of activatable channels, which may each include piezoelectric transducers (PZT), for example, which are used to jet ink from corresponding individual nozzles of the print head. The print heads are typically installed into carriages that allow the print heads to be precisely positioned to deposit ink onto the moving substrate.

A jet data generator (JDG) may be used to control the operation (e.g., provide fire pulse signals to the PZTs) and positioning of the print heads. However, at times, the nozzles of inkjet print heads may become clogged with ink, and require maintenance or replacement, which may be time consuming and therefore costly. In some instances the individual nozzles of a new print head may not be precisely aligned with the pixel wells, due to manufacturing inconsistencies or other causes, for example, which may negatively impact printing. Precise alignment of print heads within a print head carriage is typically required before printing, after a print head has been installed. Moreover, print heads typically include a fixed number of nozzles in a fixed alignment, thereby making an individual print head unsuitable for all printing applications.

Additionally, one or more cables may be used to couple the jet data generator to the print head, and the carriage supporting the print head. Conventionally, the inkjet print heads are rotated to adjust the effective pitch (space between ink drops jetted from the nozzles). In some cases, extensions to the cables coupling the jet data generator to the print head were required to allow rotation of the print head. In instances where the cables are long enough to allow rotation, the cables, as with the extensions, may either suffer wear and tear, get in the way of moving parts of the system (e.g., the rotating print head and parts facilitating movement of the print head), or may become a source of potentially contaminating particles as the cables wear.

Accordingly, a need exists for improved methods and apparatus to allow efficient replacement of print heads, as well as an improved cable design to be used with print heads that rotate while printing.

### SUMMARY OF THE INVENTION

In aspects of the invention an apparatus is provided. The apparatus comprises an adapter including one or more supply lines, wherein the one or more supply lines are adapted to transmit at least one of ink and solvent to a print head.

In other aspects of the invention, an inkjet printing system is provided. The system comprises a support carriage; an adapter coupled to the support carriage and including adjustment features; and a modular print head adapted to be releasably and adjustably coupled to the adapter.

In yet other aspects of the invention, a method is provided. The method comprises positioning an adapter proximate a mounting bracket of a support carriage; aligning the adapter in a first direction with the mounting bracket; aligning the adapter in a second direction with the mounting bracket; and coupling the adapter to the mounting bracket.

Other features and aspects of the present invention will become more fully apparent from the following detailed description, the appended claims and the accompanying drawings.

### BRIEF DESCRIPTION OF THE FIGURES

FIG. 1 is a schematic illustration of a prior art print head assembly for use in inkjet printing.

FIG. 2 is a schematic illustration of a system for use in inkjet printing in accordance with an embodiment of the present invention.

FIG. 3A is a schematic illustration of a close-up of the inkjet head assembly in accordance with an embodiment of the present invention.

FIG. 3B is a schematic illustration of a close-up of an alternate embodiment of the inkjet head assembly in accordance with an embodiment of the present invention.

FIG. 4 is a bottom perspective view of an apparatus for inkjet printing in accordance with an embodiment of the present invention.

FIG. 5 is a perspective view of an apparatus for inkjet printing in accordance with an embodiment of the present invention.

FIG. 6 is a perspective view of an apparatus for inkjet printing in accordance with an embodiment of the present invention.

FIGS. 7A-7C are schematic views of an apparatus for inkjet printing in accordance with an embodiment of the present invention.

FIG. 8 is a flowchart illustrating an exemplary method in accordance with an embodiment of the present invention.

FIG. 9 is a bottom perspective view of an apparatus for inkjet printing in accordance with an embodiment of the present invention.

FIG. 10 is a schematic illustration of an apparatus for inkjet printing in accordance with an embodiment of the present invention.

FIG. 11 is a perspective view of a pair of cables in accordance with an embodiment of the present invention.

FIG. 12 is a flowchart illustrating an exemplary method for facilitating rotation of inkjet print heads in accordance with an embodiment of the present invention.

### DETAILED DESCRIPTION

The present invention provides methods, systems and apparatus for facilitating the replacement and calibration of print heads, as well as the rotation of a print head while minimizing wear on cables that connect the print head to a controller.

An inkjet head may be a consumable part of an inkjet printing system that is periodically subject to maintenance and/or replacement in order to maintain a high degree of accuracy required due to the minute scale of the ink drops (on the order of picoliters) and pixel wells (on the order of microns). For example, even small manufacturing defects or malfunctions in a print head may cause sub-optimal printing performance. In practice, print heads are often taken off-line for maintenance due to slight defects, clogging or the like. As these heads receive maintenance or are replaced, the inkjet head positions may need to be re-calibrated with respect to the pixel wells. Using conventional print heads, shifted nozzle locations may result in a corresponding shift in the locations of printed ink drops. This can be particularly problematic where a pixel well boundary lies between the actual and intended drop locations. In such a case, an ink drop may be deposited on the wrong side of a boundary, and either an incorrect amount of ink, or an incorrect color may be deposited on one or the other (or both) wells on the two sides of the pixel well boundary. Conventionally, the re-calibration procedure is costly, as the re-calibration is time consuming, and the tool may otherwise sit idle during the re-calibration procedure.

To alleviate these difficulties, the present invention provides modular print heads that are readily removable and replaceable, enabling rapid and cost-effective substitution of a malfunctioning print head with a functional replacement, or replacement with a print head more suitable to a particular application. To realize the benefits of the use of modular print heads, a high degree of precision is required in the incorporation of a modular print head into a printing assembly because slight deviations in positioning and alignment of the print head within a printing assembly may be as damaging to printing performance as other types of malfunction, and may thus negate the benefits of the modular design. For example, to remedy the shifted nozzle problem, in some embodiments, the present invention provides for aligning a well-defined point on the print head, such as the center nozzle point, with an adapter, securing the print head after alignment to the adapter, and then affixing the adapter to a fixed location on a printer assembly. In some embodiments, the adapter may include one or more reference planes or surfaces that may correspond with reference surfaces on the inkjet tool. The position of the print head may be calibrated relative to the reference surfaces, such that when an inkjet print head coupled to an adapter is replaced by another calibrated inkjet print head, the nozzles may be positioned accurately relative to the ink wells.

There are also a number of additional related advantages to this ‘modular’ approach. For example, different print heads having varied characteristics, in terms of nozzle number, size, and spacing, may be employed and selectively incorporated into a printer assembly for specialized applications.

The systems and methods of the present invention reduce the potential downside involved in print head malfunction and/or maintenance by providing a modular print head that can be readily incorporated into a printing assembly, as a replacement or alternative. As a modular component, the print head may be designed and/or customized for a particular function. The modular print head and adapter of the present invention further allows convenient removal from a printer assembly for repair, maintenance and/or defect investigation, and easy replacement with a substitute operable print head.

The present invention is also adapted to operatively couple the inkjet head to a jet data generator (JDG) or controller; allow the inkjet head to rotate without damaging or wearing the cables; maintain a particular cable orientation; and prevent the cables from getting tangled in the moving parts (e.g., the rotating print head and parts facilitating the movement of the print head). As described above, rotation of the print heads is desirable because it allows adjustment of the pitch (distance between drops), which may allow for more accurate/precise placement of drops and may provide for a faster and more efficient throughput as the number of print passes required to print a display object may be reduced.

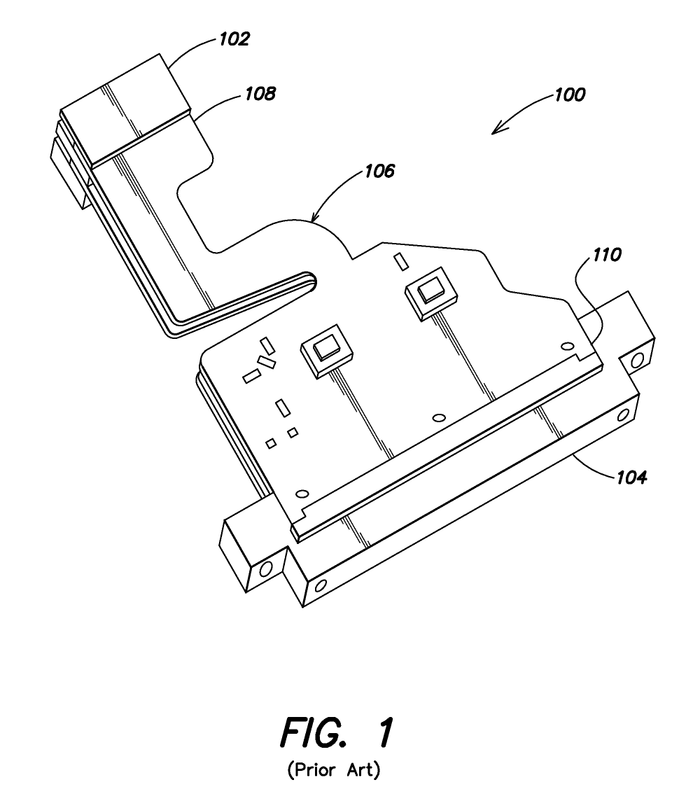

In the prior art, as shown in FIG. 1, a print head assembly 100 may include a controller 102 coupled to a print head 104 via a pair of cables 106. A first end 108 of each of the cables 106 may be configured to couple to the controller 102 and a second end 110 of each of the cables 106 may be configured to couple to the print head 104. While the cables 106 may be long enough to allow the print head 104 to rotate, the cables 106 may suffer wear and tear. Additionally, the slack from the cables 106 may get in the way of moving parts of the system (e.g., the rotating print head and parts facilitating movement of the print head, as well as other print heads). Another problem with conventional cables 106 may be that the wear and tear experienced by the cables 106 may include the cables 106 abrading against the moving parts of the assembly 100 and the cables 106 themselves, which may generate particles that may contaminate the assembly 100 and the substrate receiving the ink from the print head 104.

In an embodiment of the present invention, a first end of each cable of the set of cables may extend from opposite sides of the JDG in a somewhat parallel fashion for a pre-set length. In some embodiments, the cables may be ribbon cables. After the pre-set length, the two cables contact one another and together are configured to form a bowed-shape that extends away from the inkjet print head. The second end of each of the set of cables may be coupled to opposite sides of the inkjet print head. The two cables may attach to opposite sides of the inkjet print head to provide a path for an ink supply to attach to the inkjet print head. The bowed shape may provide the slack for the inkjet print head to rotate without wearing the cables while keeping the cables from getting tangled or contacting the inkjet print head. It should be noted that the slack is not so much that the bowed shape of the cables extends beyond the width of the print head (“foot print” of the print head) and interferes with other print heads. Additionally, the shape and location of the bowed shape formed by the two cables is such that the cables may not tangle as the inkjet print head rotates. The apparatus may include a cover to maintain a particular cable orientation, in particular, the bowed shape, and to cause the bow to form in a desired location. The apparatus may also include a support or guide to prevent the cable from getting tangled in moveable parts. Because the cables are a fixed length, the cables are bowed with the extra slack when the print head is not rotated, and when the print head is rotated, the slack is used to accommodate the rotation, thereby removing the bowed shape when fully rotated 90°. As described above, the present invention may allow the print heads to rotate during printing while minimizing wear and tear and preventing potential damage to the cable. In addition, using the inventive cables instead of the conventional cables may result in greatly reduced particle generation since the inventive cables may extend to accommodate print head rotation without having to endure wear and tear in the form of abrading against the moving parts of the print head assembly and the cables themselves. The cover, described above, may also ensure that any particles that may be generated are contained so as to prevent contamination of the print head assembly and the substrate receiving the ink from the print heads.

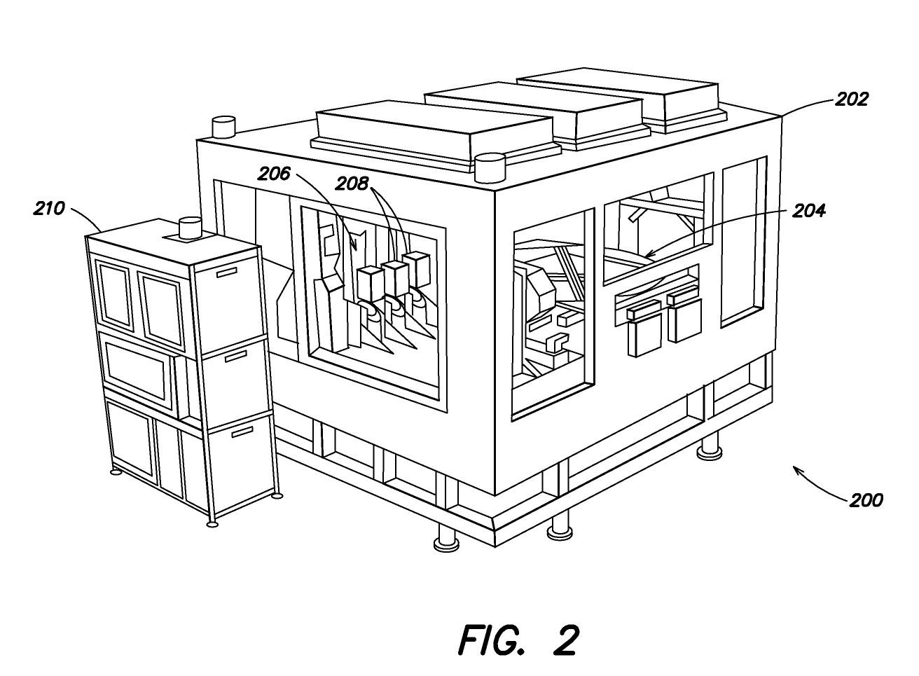

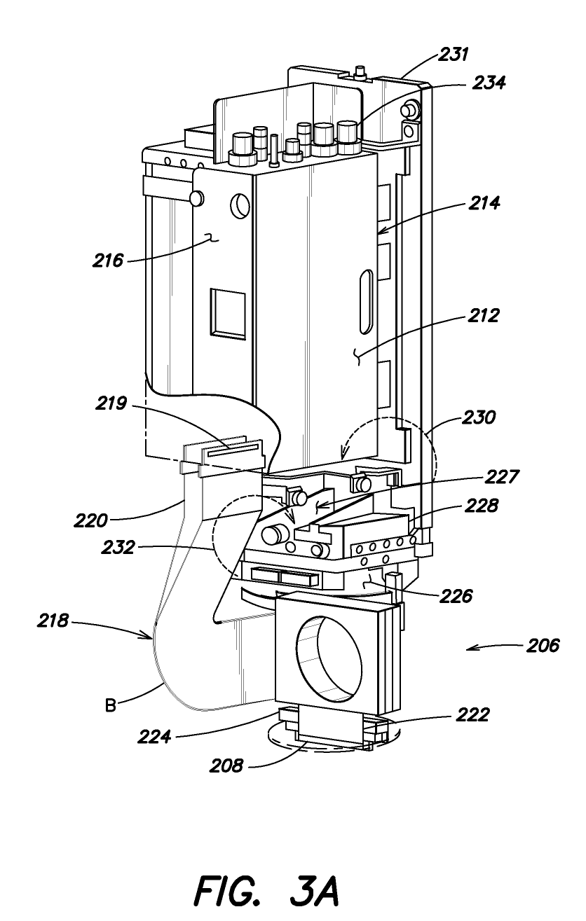

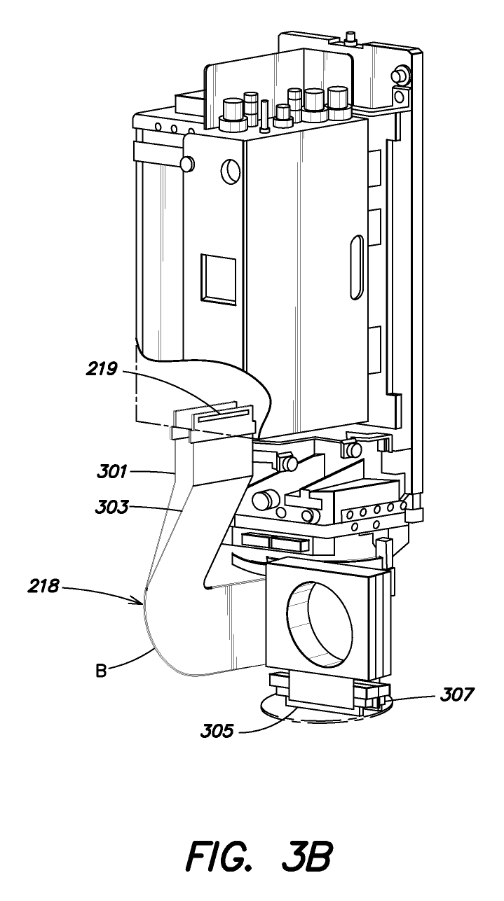

Turning to FIG. 2, a schematic illustration of a system 200 for use in inkjet printing is depicted. The system 200 may include an inkjet printing enclosure 202, which may provide a clean environment for inkjet printing. Enclosed in inkjet printing enclosure 202 may be inkjet station 204. The inkjet station 204 may provide means (e.g., motors) for positioning an inkjet print head assembly 206. Inkjet print head assembly 206, a close-up view of which is provided in FIG. 3, may include one or more inkjet print heads 208 and a head pneumatic module. As described above, in some examples, the print head 208 may include a plurality of activatable channels, which may comprise piezoelectric transducers (PZT), for example, which provide ink to corresponding individual nozzles of the print head. In some embodiments the nozzles may be oriented in a nozzle plate (not shown). In some embodiments, the channels may be independently operable. The inkjet print head may include, for example, 128 PZT channels and nozzles. The print head 208 may, in some examples, be able to rotate 90 degrees. An ink delivery module 210, may be coupled (e.g., in fluid communication and/or electrically) to the inkjet printing system enclosure 202 and may be adapted to deliver the ink to the print heads 208. An exemplary embodiment of an ink delivery module is described in application Ser. No. 60/868,313 for “INKJET PRINT HEAD PRESSURE REGULATOR” (11522/L) and is hereby incorporated by reference in it's entirety.

As shown in FIG. 3A, and as described above, the print head assembly 206 may include a carriage 212, for example, to support the print head 208. The carriage 212 may include a support frame 214 adapted to provide mechanical support for several of the components of the carriage 212. The carriage 212 may also include a controller 216 coupled thereto, for example. The controller 216 may be coupled to the print head 208 via a pair of cables 218, for example, at a cable connector 219, for example. Each cable of the pair of cables 218 may include a number of distinct electrically-conductive channels (e.g., wires). In some embodiments, each cable 218 may have at least 64 conductor lines to operate 64 nozzle Piezo actuators of print head 208. As described above, a first end 220 of each cable of the pair of cables 218 may extend from opposite sides of the cable connector 219 in a somewhat parallel fashion for a pre-set length, such as several inches, for example. Other suitable pre-set lengths may be used. The channels in the print head 208 may be controllable via signals transmitted from the controller 216 through the cables 218. In some embodiments, the jetting of ink through each individual nozzle of the print head 208 may be controlled by the individual channels that are activated or deactivated in response to signals transmitted by the controller 216. After the pre-set length, the two cables contact one another and together are configured to form a bowed-shape (B) that extends away from the inkjet print head 208. A second end 222 of each of the pair of cables 218 may be coupled to opposite sides of the inkjet print head 208. The two cables 218 may attach to opposite sides of the inkjet print head 208 to provide a path for an ink supply to attach to the inkjet print head 208.

In some embodiments, as shown in FIG. 3B, a first cable 301 of the pair of cables 218 may be connected to a first print head 305, and a second cable 303 of the pair of cables 218 may be coupled to a second print head 307. The first and second cables 301, 303, may be disposed so that a gap between the first and second cables 301, 303 is sufficient to provide ink to the first and second print heads 305, 307. However, each of the first and second cables 301, 303, may include sufficient length so that a bow is formed when the modular print heads are disposed in a first position and the bow allows the modular print heads to rotate to a second position without stretching the conductors.

While the controller 216 is shown to be hardwired (via the cable connector 219 and cables 218) to the print head 208, in some embodiments the controller 216 may be, for example, wirelessly coupled to the print head 208. The controller 216 may be a microcomputer, microprocessor, microcontrollers, dedicated analog and/or digital circuits, logic circuits, memory components, a combination of hardware and software, or the like, adapted to generate signals for controlling inkjetting. The controller 216 may transmit such signals through one or more output ports to the modular print head assembly 206.

In one or more embodiments, the print head 208 may be aligned with, and secured to, an adapter 224, described further below. In some embodiments, the adapter 224 may be approximately T-shaped, having an elongated top cross-bar having a length at least equal to the longitudinal length of the nozzle plate of the print head 208 (e.g., in the direction in which the line of nozzles on the nozzle plate extends).

The adapter 224 may be coupled to preset positions on a first end of the supporting frame 214, and thereby the modular print head assembly 206 may be secured to the carriage 212 via its coupling to the adapter 224. The frame structure 214 may be coupled at a second end to a platform, or print head rotation stage, 226 adapted to rotate in a horizontal plane about a vertical axis by operation of one or more motors. Rotation of the platform 226 may be controlled by the controller 216, or any other controller, to set the orientation or ‘saber angle’ of the print head 208 in the horizontal (X-Y) plane. The platform 226 may, in turn, be rotatably coupled (e.g., by bearings, washers, etc.) to the support frame 214.

In one or more embodiments, the carriage 212 may include mechanisms for adjusting the relative position and orientation of the print head 208 within the carriage 212. For example, a print head adjustment mechanism 227 may include a pitch adjustment mechanism 228, which may provide for fine manual or automatic adjustments of the pitch 230, or orientation about the ‘x’ axis, indicated by the curved dashed arrow, and a roll adjustment mechanism 231 may provide for fine manual or automatic adjustments of the roll 232, or orientation about the ‘y’ axis, indicated by the curved dashed arrow, of the platform 226, if, and when, desired. The magnitude of the pitch and/or roll adjustments may be on the order of several degrees, or any other suitable adjustment.

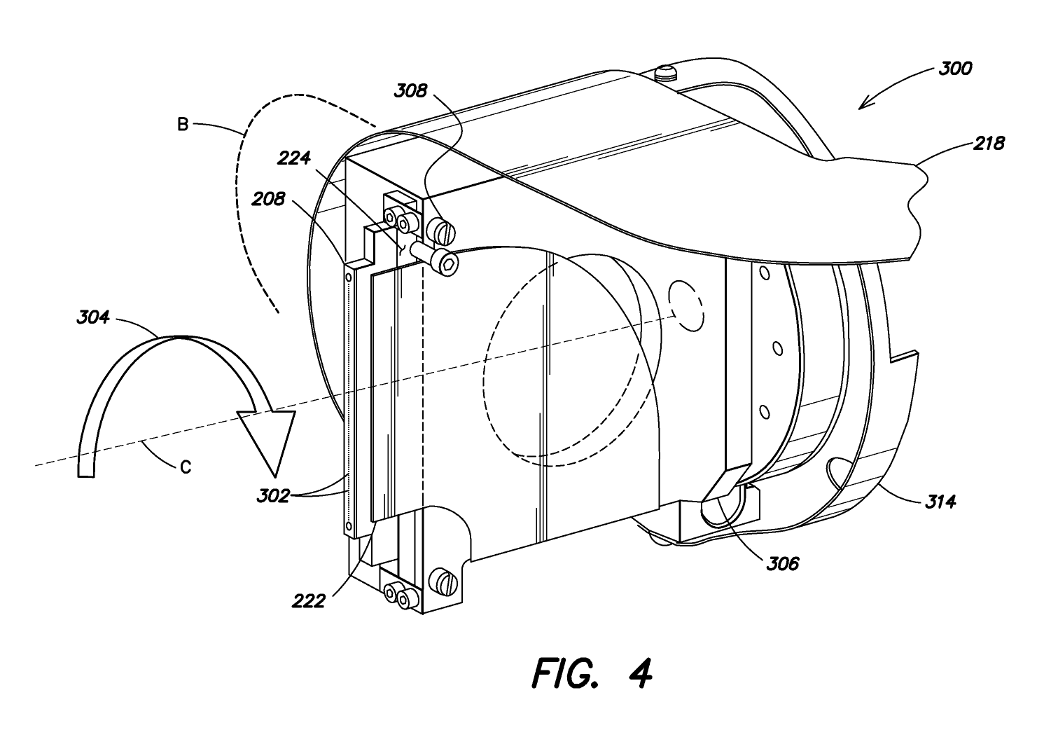

Turning to FIG. 4, a schematic illustration of an apparatus 300 including the print head 208 and cables 218 described above with respect to FIG. 3A is depicted. As described above, the print head 208 may, for example, include 128 nozzles 302 adapted to deposit ink onto a moving substrate (not shown). The print head 208 may, for example, rotate about a central line (C) from 0 to 90 degrees, as indicated by the directional arrow 304. As described above, the rotation may allow for the adjustment of the effective pitch 230 (space between ink drops jetted from the nozzles 302), and thereby allow for a more accurate/precise placement of drops and may provide for a faster and more efficient throughput as the number of print passes required to print a display object may be reduced.

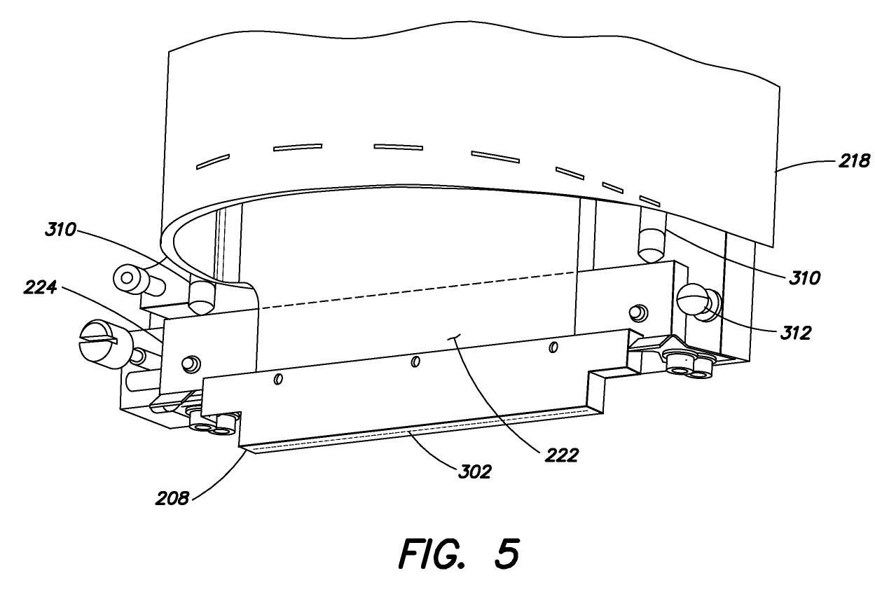

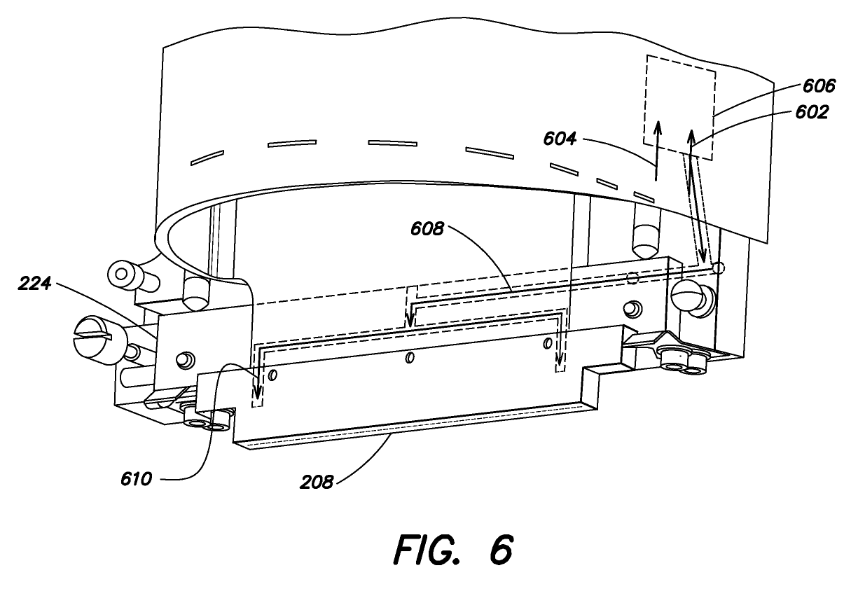

The print head assembly 206 may further include a mounting bracket 306. In some embodiments, the mounting bracket 306 may include ink and solvent supply lines, described further below with respect to FIG. 6. In some embodiments, the adapter 224 may be coupled to the mounting bracket 306 via screws 308, for example, or any other suitable coupling device. In some embodiments, during the installation of the adapter 224 to the print head assembly 206, the adapter 224 and print head assembly 206 may be aligned such that it may not be necessary to adjust the alignment when the print head 208 is to be replaced. In some embodiments, the adapter 224 may include at least two alignment mechanisms 310 (FIG. 5) for alignment in the Z-direction (height). The adapter 224 may also include at least one alignment mechanism 312 (FIG. 5) for alignment in the X-direction. In some embodiments, the alignment mechanisms 310, 312 may be sensors, which may be operated by the controller 216, for example. Other suitable alignment mechanisms may be used. In some embodiments the print head 208 and the adapter 224 may be pre-aligned at an alignment bench (not shown) or at the manufacturer, for example, and the alignment mechanisms 310 and 312 may be aligned with the adapter 224. In this manner, the alignment may be maintained when the print head 208 and adapter are replaced. In alternate embodiments, the alignment may occur while the print head 208 and adapter 224 are coupled to the print head assembly 206, via a jig and/or through automated means. The alignment mechanisms may be spherical, for example, to facilitate manipulation of the adapter in any direction during the alignment procedure. Other suitably shaped alignment mechanisms may be used. In some embodiments, after the alignment between the print head assembly head 206 and the adapter 224 is confirmed, the print head assembly 206 may be coupled to the adapter 224 via any suitable coupling means, such as an adhesive, for example.

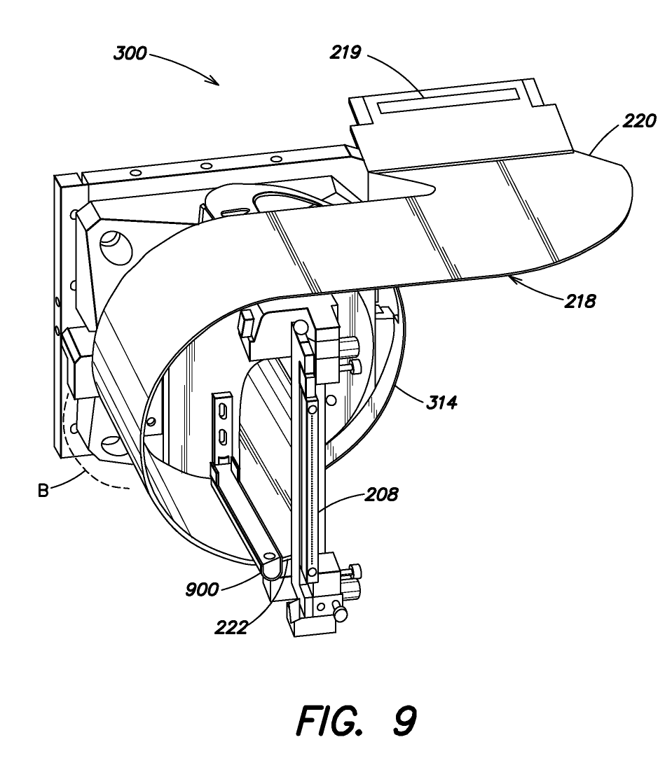

As can be seen in FIG. 9, the first end 220 of the pair of cables 218 is coupled to the cable connector 219. As shown in FIGS. 4 and 9, the pair of cables 218 is in contact with one another and appears as a single cable as they extend over a portion of the print head 208 such that the second ends 222 of the cables 218 may be coupled to opposite sides of the print head 208.

The apparatus 300 may further include a cable guide 314 adapted to guide the cables 218 over the print head 208. As will be further described below, the cable guide 314 may be shaped to prevent the cables 218 from getting tangled in the moveable parts of the apparatus 300 as the print head 208 rotates. As shown herein, the cable guide 314 may be shaped as a backwards “C”. However, other suitable shapes may be used. The cable guide 314 may be coupled to the apparatus 300 by any suitable means in a stationary manner. The cable guide 314 may rotate with the print head 208. The cable guide 314 may be made of metal, plastic or any other suitable material.

Turning to FIG. 6, a perspective view of an apparatus 300 for inkjet printing in accordance with an embodiment of the present invention is provided. As described above, the mounting bracket 306 (FIG. 4) may include ink 602 and solvent 604 supply lines adapted to transport ink and solvent from an ink reservoir or supply and a solvent reservoir or supply in the ink delivery module 210 to the nozzles 302 in the print head 208, via an ink/solvent interface 234 (FIG. 3A). In some embodiments, a combination of ink and solvent may be jetted from the nozzles 302 (FIG. 4). In some embodiments, a valve 606 in the mounting bracket 306, for example, may selectively direct the flow of ink and solvent from the supplies. The valve may be a two-, three- or four-way valve, or any other suitable valve. Exemplary valves suitable for use may include gate valves, needle valves, bellow valves, diaphragm valves, or ball valves, or other types of valves. The valve 606 may be electronically controlled, for example, by the controller 216. The adapter 224 may further include an adapter ink and solvent supply line 608. The adapter ink and solvent supply line 608 may be fluidically coupled to the ink 602 and solvent 604 supply lines in the mounting bracket 306. The print head 208 may also include a print head ink and solvent supply line 610. The print head ink and solvent supply line 610 may be fluidically coupled to the adapter ink and solvent supply line 608. For example, in response to information indicating the print head 208 is ready to eject ink, the controller 216 may open the valve 606, thereby allowing the ink and solvent to flow from the ink 602 and solvent 604 supply lines into the ink and solvent supply line 608, and then into the print head ink and solvent supply line 610, and out through the nozzles 302. The adapter 224 and the print head 208 may include one or more ink and solvent supply lines 608, 610, respectively. Any suitable number of ink and supply lines may be used. The path of the ink and solvent is indicated in FIG. 6 by the dotted arrowed lines.

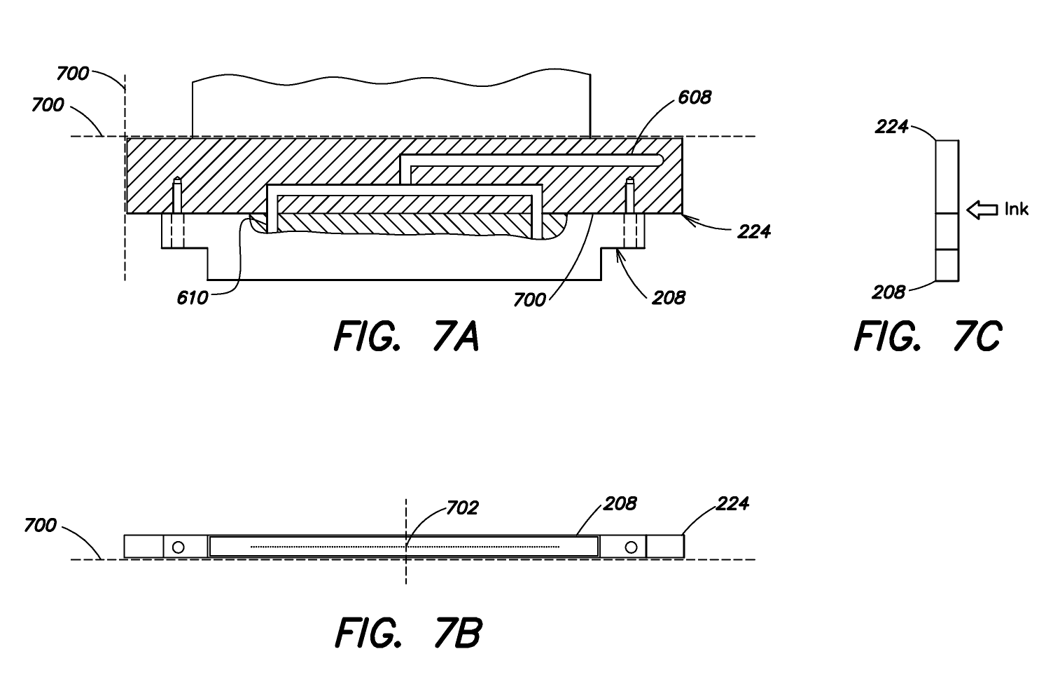

Turning to FIGS. 7A-C, schematic views of exemplary embodiments of the adapter 224 and print head 208 of the present invention are provided. As described above, the adapter 224 may include one or more reference or alignment surfaces 700. In the embodiments shown herein, the adapter 224 includes three reference surfaces 700. These reference surfaces 700 may be used to align the adapter 224 during the initial installation of the adapter 224 to the print head 208. In some embodiments, it may not be necessary to adjust the adapter 224 during replacement of the print head 208, as the adapter ink and solvent supply line 608 may be easily connected and disconnected to the print head ink and solvent supply line 610. During installation of the print head 208, a pre-defined nozzle 702 may be used to align the print head 208 with the reference surfaces of the adapter 224. The pre-defined nozzle 702 may be the center nozzle, or any other suitable nozzle. In some embodiments, a center of the pre-defined nozzle 702 may be used during alignment. In some embodiments, the pre-defined nozzle 702 may be aligned with the reference surfaces 700 via a microscope, a robot, feedback sensors or any other suitable alignment mechanisms. After the adapter 224 and print head 208 are aligned, the adapter 224 and print head 208 may be matably coupled via bolts, screws, adhesives, or any other suitable coupling means.

The present invention may allow a print head to be replaced quickly (e.g., in less than a few minutes) and may eliminate the need for mechanical adjustment, particularly during the replacement process. Some inkjet print heads may be considered to be a consumable part, and may be replaced after three or four months of operation (e.g., print heads may have a 25 billion drop life). For example, a production line for color filters for flat panel displays may be typically designed to achieve a printing rate of approximately 120 substrates (flat panel displays) per hour throughput. In such an example, approximately 72 print heads may be required to be replaced every three or four months. The mechanical position tolerance of a print head nozzle may be +/−25 micrometers. Process requirements may specify that the print head nozzle position is to be adjusted, after each replacement, to achieve a level of accuracy that is less than +/−5 micrometers. According to the present invention, the print head 208 may be mechanically pre-aligned to the adapter 224, to reduce nozzle alignment error from +/−25 um to the +/−5 um level.

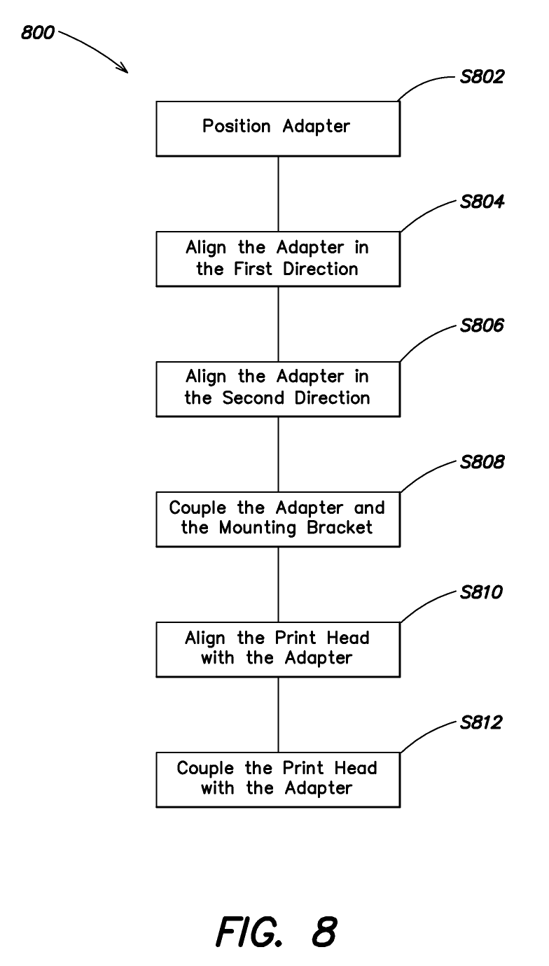

Turning to FIG. 8, an exemplary method 800 for installing the adapter 224 and aligning the print head 208 with the adapter 224 is provided. In step S802, the adapter 228 is positioned proximate the mounting bracket 306. In step S804, the adapter 224 is aligned in a z-or first-direction, via the z-alignment mechanisms 310, with the print head assembly 206. In some embodiments, the alignment mechanisms may include sensors. In step S806, the adapter 224 is aligned in the x- or second-direction, via the x-alignment mechanism 312, with the print head assembly 206. It should be noted that steps S804 and S806 may occur in any order. The adapter 224 may then be coupled to the mounting bracket 306 of the print head assembly 206 in step S808. As described above, the coupling may occur via screws 308, bolts, adhesives, or any suitable coupling device. Then in step S810, the print head 208 is aligned with the adapter 224. As described above, the reference surfaces 700, as well as the pre-defined nozzle 702 may be used to align the print head 208 with the adapter 224. Then in step S812, the print head 208 may be coupled to the adapter 224. As described above, the adapter 224 and print head 208 may be coupled via bolts, screws, adhesives, or any other suitable coupling means. In some embodiments, a sensor, for example, may determine that the print head 208 may need be replaced, based on, for example, detected number of drops jetted from the nozzles, detected build-up in the nozzles. The controller 216 may also determine that a print head 208 is due for replacement based on a pre-defined date, or hours of usage, for example. Other suitable methods for determining the print head 208 may need to be replaced may be used.

Turning to FIG. 9, a bottom perspective view of the apparatus 300, shown in FIGS. 3 and 4, for inkjet printing in accordance with an embodiment of the present invention is provided. The apparatus 300 may further include a cable clamp 900 adapted to maintain the second ends 222 of the cables 218 coupled to the print head 208. The cable clamp 900 may be made of metal, plastic or any other suitable material. In operation, when the print head 208 is at rest, the cables 218 extend away from the print head 208 to form a bowed shape (B) as indicated by the dotted line, also shown in FIG. 4. As noted above, the bowed shape (B) is not so great that the bowed shape (B) of the cables 218 extends beyond the width of the print head 208 (“foot print” of the print head) and interferes with other print heads (not shown). As the print head 208 begins to rotate, as indicated by directional arrow 304, shown in FIG. 4, the bowed shape (B) or slack formed by the cables 218 may be used to allow the print head 208 to rotate without wearing the cables 218, while keeping the cables 218 from getting tangled or contacting the print head 208. Additionally, because the cables 218 are a fixed length, as the print head 208 beings to rotate, the portion of the cables 218 at the end closer to the controller 216 may begin to have extra slack. This slack in the cables 218 may, for example, get caught in the moving parts as the print head 208 rotates. However, the cable guide 314, as described above, may be positioned such that the cable guide 314 supports the slack in the cables 218 and prevents the cables 218 from getting tangled in the moving parts of the apparatus 300.

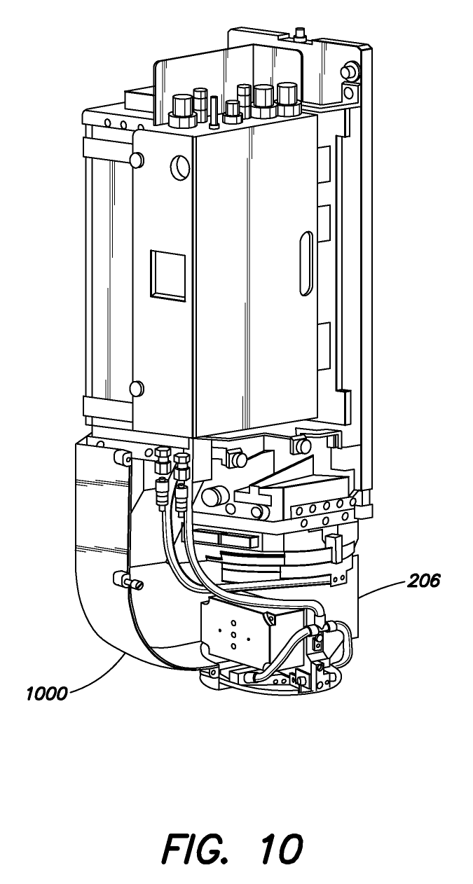

Turning to FIG. 10, the print head assembly 206 shown in FIG. 10 is the same print head assembly as shown and described above with respect to FIG. 3, except the print head assembly 206 shown in FIG. 3 includes an inventive cover 1000, as described above. Accordingly, only the inventive cover 1000 is described with reference to FIG. 10.

As described above, the extra slack in the cables 218 may form a bowed-shape when the print head 208 is stationary. However, this bowed-shape may form at any location along the length of the cables 218, including locations that may result in the cables 218 getting tangled in moving parts and/or interference with other print heads. The cover 1000 may be shaped and coupled to the assembly 206 such that the cover 1000 may act as a guide to form the bowed-shape in a particular location. The cover 1000 may be made from plastic, metal or any other suitable material. The cover 1000 may also prevent the print head assembly 206 from being exposed to any particulates generated during other processes.

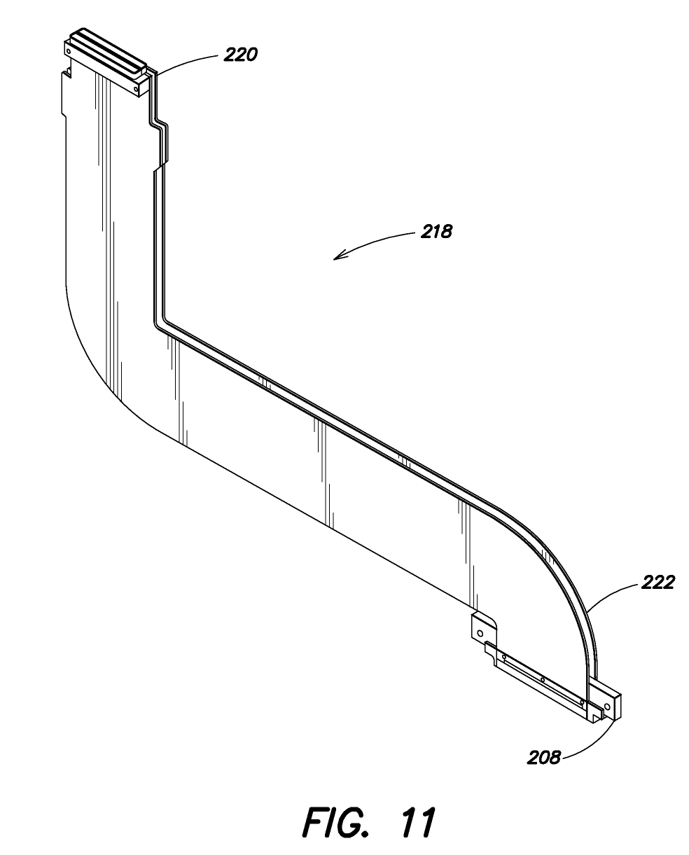

Turning to FIG. 11, a plan view of the one of the pair of inventive cables 218 shown in FIGS. 3-6 and 9-10 is depicted here. As described above, the first end 220 of the cables 218 couples to the controller 216 and the second end 222 of the cables 218 couples to the print head 208. As can be seen in the planar view, the cables 218 have a quasi-S shape. The quasi-S shape may allow the print heads 208 to rotate during printing while minimizing wear and tear of the cables 218 in addition to preventing potential damage to the cables 218.

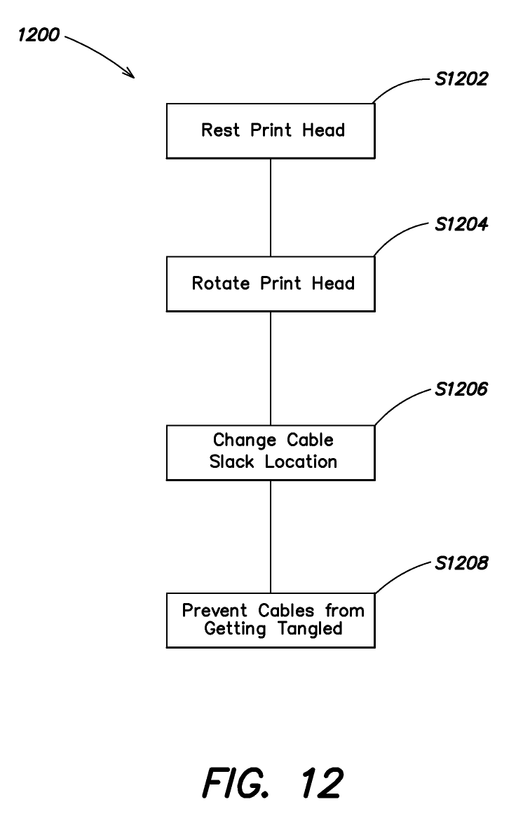

Turning to FIG. 12, a flowchart illustrating an exemplary method 1200 for facilitating rotation of inkjet print heads is depicted. In step S1202, the print head is at rest. As described above, as the print head is at rest, a portion of the cables may have a bowed shape. Then in step S1204, the print head begins to rotate. As described above, the rotation may range between 0 and 90 degrees. Then in step S1206 the location of the slack in the cables changes. As described above, the slack in the cables forming the bowed-shape is taken up by the rotation of the print head, causing the bowed-shape to decrease until the rotation ceases. However, because the cables are a fixed length, the portion of the cables at the end closer to the controller may now have extra slack. In step S1208, the cable guide prevents the cables from getting tangled in the moving parts as the print head rotates.

The present invention reduces the time required to replace inkjet print heads, it improves the positional accuracy of inkjet head, and it improves the print head cable and ink supply line management. The cables are connected at both the front and the back side of print head and the ink supply lines are conventionally located between the cables. In some embodiments, the present invention relocates the ink supply line interface so that the supply line is outside the cables.

The foregoing description discloses only exemplary embodiments of the invention. Modifications of the above disclosed apparatus and methods which fall within the scope of the invention will be readily apparent to those of ordinary skill in the art. For example, a flexible form or shape may be used to maintain the cables in the proper orientation instead of the cover. The flexible form may be made from plastic of any other suitable material. The flexible form may be coupled to the cables. In another example, the cables may be coiled and when stretched may provide enough slack to allow the inkjet head to rotate without wear and tear of the cables.

Accordingly, while the present invention has been disclosed in connection with exemplary embodiments thereof, it should be understood that other embodiments may fall within the spirit and scope of the invention, as defined by the following claims.

The invention claimed is:

1. An apparatus for inkjet printing comprising:
an adapter for adjustably securing a print head to a support carriage, the adapter including one or more supply lines, wherein the one or more supply lines are adapted to transmit at least one of ink and solvent to the print head.

2. The apparatus of claim 1 wherein the adapter includes one or more alignment mechanisms.

3. The apparatus of claim 2 wherein the alignment mechanisms are adapted to align the adapter with the support carriage of an inkjet printing system.

4. The apparatus of claim 2 wherein the alignment mechanisms are adapted to align the print head of an inkjet printing system.

5. An inkjet printing system comprising:
a support carriage;
an adapter coupled to the support carriage and including adjustment features; and
a modular print head adapted to be releasably and adjustably coupled to the adapter.

6. The system of claim 5 further comprising:
a controller, coupled to the modular print head, wherein the controller is adapted to control the operation of the modular print head.

7. The system of claim 5 wherein the adapter includes one or more supply lines.

8. The system of claim 7 wherein at least one of ink and solvent flow through the one or more supply lines.

9. The system of claim 7 wherein the print head includes one or more supply lines.

10. The system of claim 9 wherein the one or more supply lines in the print head are fluidically coupled to the one or more supply lines in the adapter.

11. The system of claim 5 wherein the support carriage includes a mounting bracket, and the adapter is adapted to be coupled to the mounting bracket.

12. The system of claim 11 wherein the adapter includes one or more references surfaces.

13. The system of claim 12 wherein the one or more reference surfaces are adapted to align the adapter with the print head.

14. The system of claim 5 wherein the print head includes a plurality of nozzles adapted to jet ink.

15. The system of claim 14 wherein the nozzles include a pre-determined alignment nozzle.

16. The system of claim 15 wherein the pre-determined alignment nozzle is adapted to align the print head with the adapter.

17. The system of claim 6 further comprising:
a first plurality of conductors coupled between a first connector adapted to couple to the modular print head and a second connector adapted to couple to the controller; and
a second plurality of conductors coupled between the first connector and the second connector,
wherein the first and second pluralities of conductors are adapted to allow rotation of the modular print head relative to the controller while minimizing wear on the first and second pluralities of conductors.

18. The system of claim 17 wherein the first and second pluralities of conductors each include a ribbon cable.

19. The system of claim 17 wherein the modular print head includes two print heads and wherein the first plurality of conductors is coupled to a first print head and the second plurality of conductors is coupled to a second print head.

20. The system of claim 19 wherein the first and second pluralities of conductors are disposed so that a gap between the first and second pluralities of conductors is sufficient to allow one or more ink supply channels to provide ink to the first and second print heads.

21. The system of claim 17 wherein the first and second pluralities of conductors each include sufficient length so that a bow is formed when the modular print head is disposed in a first position and the bow allows the modular print head to rotate to a second position without stretching the conductors.

22. The system of claim 21 wherein the first position is ninety degrees or less from the second position.

23. The system of claim 18 further comprising:
a cover adapted to maintain a shape and an orientation of the cables; and
a guide adapted to prevent the cable from interfering with the modular print head while the modular print head rotates.

24. A method comprising:
positioning an adapter proximate a mounting bracket of a support carriage;
aligning the adapter in a first direction with the mounting bracket;
aligning the adapter in a second direction with the mounting bracket; and
coupling the adapter to the mounting bracket.

25. The method of claim 23 further comprising:
aligning a print head with the adapter and coupling the print head to the adapter
